(19) United States
(12) Patent Application Publication
(10) Pub. No.: US 2013/0272012 A1
(43) Pub. Date: Oct. 17, 2013

(54) LIGHT BAR EXTERIOR CABLE JUNCTION BOX

(71) Applicant: CODE 3, INC., St. Louis, MO (US)

(72) Inventor: Mark Thibodeau, St. Louis, MO (US)

(73) Assignee: CODE 3, INC., St. Louis, MO (US)

(21) Appl. No.: 13/796,030

(22) Filed: Mar. 12, 2013

Related U.S. Application Data
(60) Provisional application No. 61/623,682, filed on Apr. 13, 2012.

(51) Int. Cl. F21V 15/01; H02G 3/08

(52) U.S. Cl. CPC F21V 15/01; H02G 3/08
USPC 362/546; 174/520; 29/868

(57) ABSTRACT

A junction box assembly for a light bar for splicing a light bar cable and a vehicle cable. A multipart housing forms a compartment and has at least two separable parts for accessing the compartment. The compartment is configured for receiving an end of the light bar cable and for receiving an end of the vehicle cable. The multipart housing is configured to mount externally and slidably to the underside of the light bar.

### BACKGROUND

Vehicles having light bars are in use for longer periods of time. As a result, the existing vehicle light bars need to be upgraded or replaced with a new, different, improved, or refurbished light bar (i.e., a replacement light bar). Frequently, the existing vehicle light bar cable connected between the vehicle and the existing vehicle light bar does not necessarily need to be replaced. However, the existing vehicle light bar cable is not always long enough or compatible with the replacement light bar.

### SUMMARY

In one form, a junction box assembly for a replacement light bar for splicing a replacement light bar cable and an existing vehicle light bar cable is provided. A multipart housing forms a compartment and has at least two separable parts for accessing the compartment. The compartment is configured for receiving an end of the replacement light bar cable and for receiving an end of the existing vehicle light bar cable. The multipart housing is configured to mount externally to the underside of the replacement light bar.

In another form, a method installs a replacement light bar having a replacement light bar cable connected to a plurality of light emitting devices of the replacement light bar. The method installs the replacement light bar to a vehicle having an existing vehicle light bar cable connected to a power supply of the existing vehicle. An end of the replacement light bar cable is spliced to an end of the existing vehicle light bar cable. The spliced ends of the cables are enclosed in a junction box. The junction box is attached to the replacement light bar.

In another form, a replacement light bar for connection to an existing vehicle light bar cable is provided. The replacement light bar comprises a frame, at least one module attached to the frame and having a plurality of light emitting devices connected to a replacement light bar cable, and a junction box assembly mounted to the frame and defining an compartment for receiving an end of the replacement light bar cable and for receiving an end of the existing vehicle light bar cable.

### BRIEF DESCRIPTION OF THE DRAWINGS

FIG. 1 is a perspective view of one embodiment of the invention of a first housing for mounting to a support plate.

FIG. 2 is a perspective view of one embodiment of the invention of a second housing for mounting on and joining the first housing of FIG. 1.

FIG. 3 is a plan elevational view of one embodiment of the invention of a support plate.

FIG. 4 is a perspective view of the second housing of FIG. 2 on the first housing of FIG. 1 with the second housing mounted to the support plate of FIG. 3.

FIG. 5 is a perspective view of the second housing of FIG. 2 on the first housing of FIG. 1, the first housing of FIG. 1 mounted to the support plate of FIG. 3 and the support plate attached to a replacement light bar. A replacement light bar cable and an existing vehicle light bar cable are joined by splicing within the first housing and second housing, according to one embodiment of the invention.

FIG. 6 is a perspective view of the first housing of FIG. 1 mounted to the support plate of FIG. 3 with the support plate attached to a replacement light bar and including a replacement light bar cable and an existing vehicle light bar cable joined by splicing within the first housing, according to one embodiment of the invention. FIG. 6 illustrates FIG. 5 without the second housing.

FIG. 7 is a block diagram of a replacement light bar and a junction box connected to the replacement light bar, wherein the replacement light bar cable is spliced to an existing vehicle light bar cable via the junction box according to one embodiment of the invention.

### DETAILED DESCRIPTION

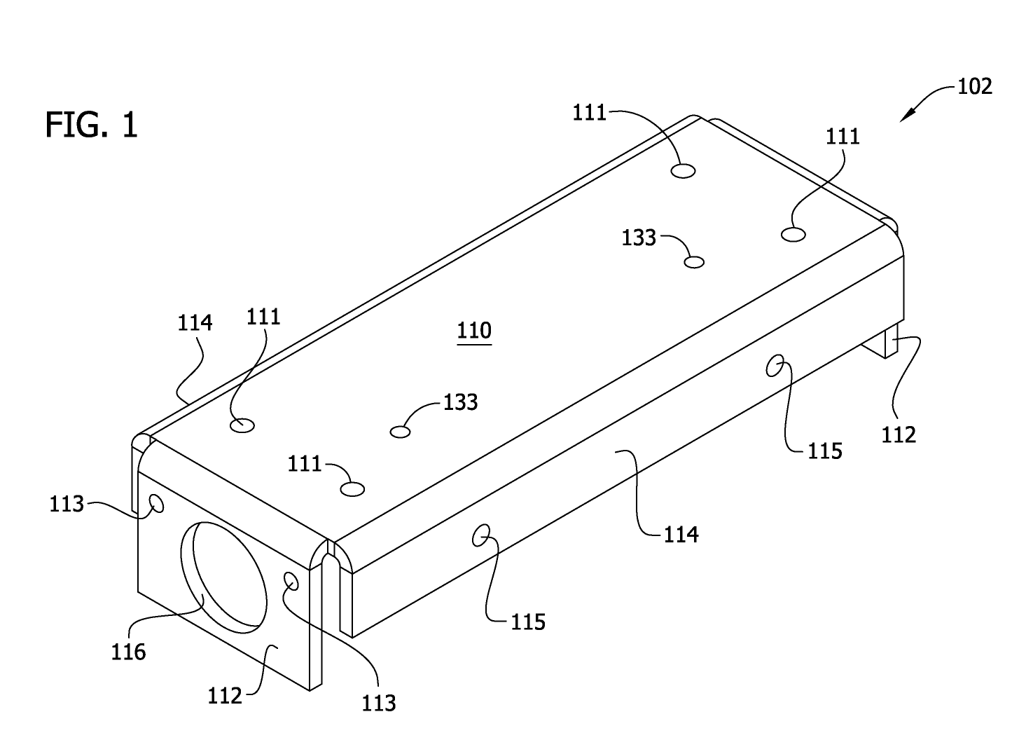

As shown in FIGS. 1-7, a junction box assembly 100 for a replacement light bar 200 of a vehicle 208 is illustrated, the junction box assembly 100 for splicing a replacement light bar cable 203 and an existing vehicle light bar cable 205 connected to the replacement light bar 200. In one embodiment, one purpose of the junction box assembly 100 is for use when a vehicle 208 which has had a previous existing light bar installed is being retrofitted with a new, different, improved, or refurbished light bar (i.e., a replacement light bar 200. Frequently, the existing vehicle light bar cable 205 of the previous light bar installed in the vehicle may be different than the replacement light bar cable 203 of the retrofitted light bar 200. For example, the existing vehicle light bar cable 205 of the previous light bar installed in the vehicle may have more wires than the replacement light bar cable 203 of the retrofitted light bar. As another example, the existing vehicle light bar cable 205 of the previous light bar installed in the vehicle may have different color-coded wires than the replacement light bar cable 203 of the retrofitted light bar 200. Uninstalling the existing vehicle light bar cable 205 and installing the replacement light bar cable 203 in its place frequently adds time and labor expenses to the installation process. Instead, the junction box assembly 100 allows the installer to splice the existing vehicle light bar cable 205 to the replacement light bar cable 203, thereby saving time and avoiding some labor costs. By employing the junction box assembly 100, the vehicle cable 205 of the previous light bar installed in the vehicle does not need to be removed or replaced and the replacement light bar cable 203 does not need to be installed in its place. Instead, the junction box assembly 100 allows the existing vehicle light bar cable 205 of the previous light bar installed in the vehicle to remain and place and to be used by splicing one end 202 of the replacement light bar cable 203 of the retrofitted light bar 200 to one end 204 of the existing vehicle light bar cable 205. Thus, the junction box assembly 100 reduces installation time and cost.

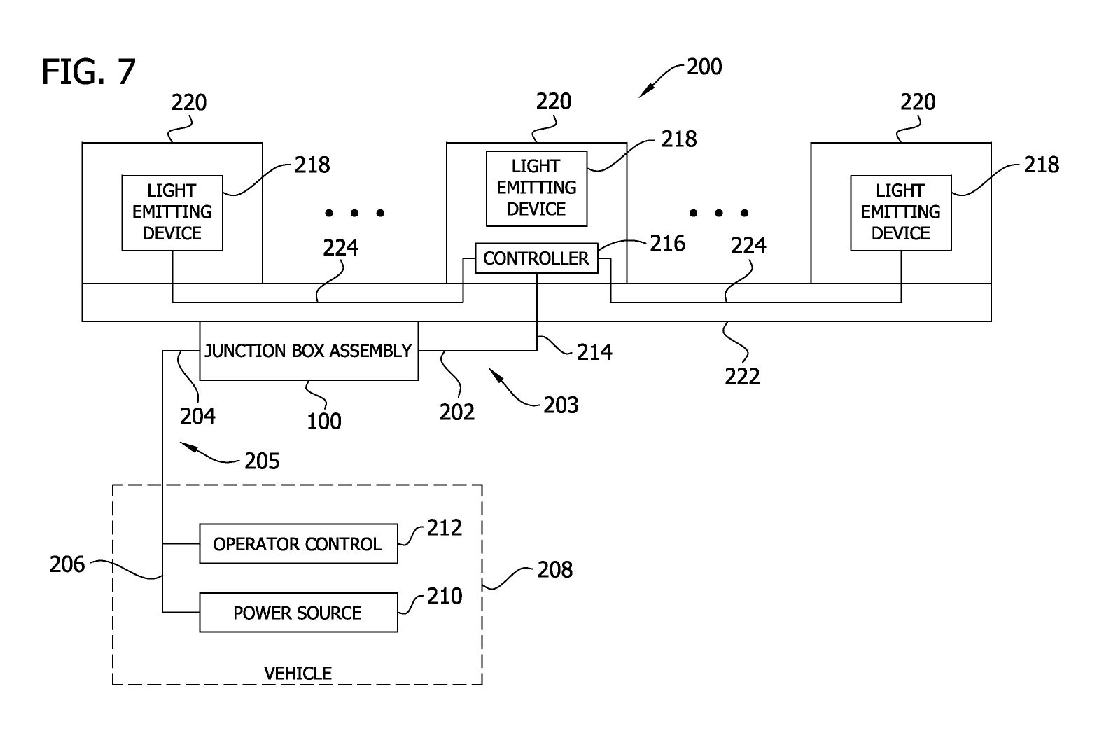

As shown in FIG. 7, the other end 206 of the existing vehicle light bar cable 205 of the previously existing light bar of the vehicle installed in the vehicle 208 is connected to a power source 210 (e.g., a vehicle battery) and to an operator control 212 for use by an operator for controlling the light bar 200. The other end 214 of the replacement light bar cable 203 of the retrofitted light bar 200 is connected to a controller 216. The controller 216 is connected by a wire harness 224 to light emitting devices 218 within one or more modules 220 of the light bar 200, for selectively energizing the devices 218. In some embodiments, the other end 214 of the light bar cable 203 of the retrofitted light bar 200 may be connected directly to the light emitting devices 218 for selectively energizing the light emitting devices 218 within one or more modules 220 of the light bar 200. Some wires of the replacement light bar cable 203 may also be connected to a siren or speaker, not shown. In some retrofitted installations, the ability to splice the existing vehicle light bar cable 205 of the existing vehicle light bar to the replacement light bar cable 203 of the replacement light bar 200 to be installed on the vehicle 208 may depend upon the wiring requirements of the retrofitted operator control 212 as well as the number of wires of the replacement light bar cable 203 of the retrofitted light bar 200. In some cases, the operator control 212 may have to be replaced.

The junction box assembly 100 in one embodiment comprises a multipart housing of two or more parts (e.g., shells) forming a water resistant compartment. The parts of the housing are separable to provide access to the compartment. For example, the multipart housing may be a first housing 102 and a second housing 104 for engaging the first housing 102. The first housing 102 and second housing 104, when mated to each other, define a compartment 108 therebetween for receiving the end 202 of the replacement light bar cable 203 and for receiving the end 204 of the existing vehicle light bar cable 205. The multipart housing is mounted to an exterior of a light bar. For example, an optional support plate 106 may be mounted to the first housing 102 for engaging the underside of the light bar 200. The assembly 100 may be formed of metal, plastic, carbon fiber or any other rigid, water resistant material.

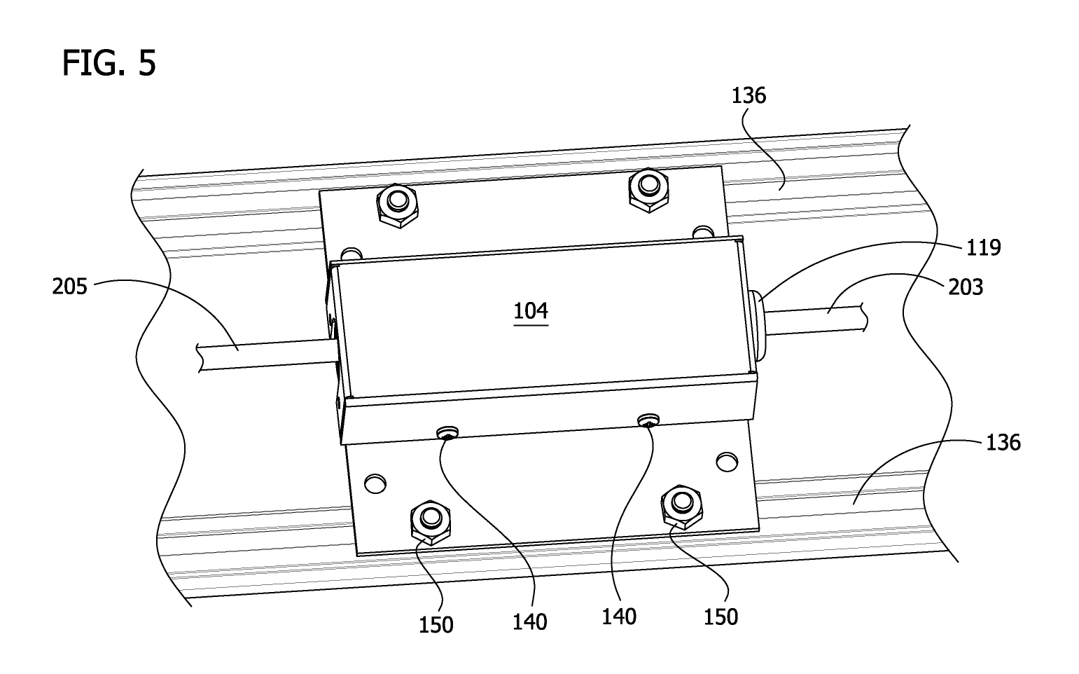

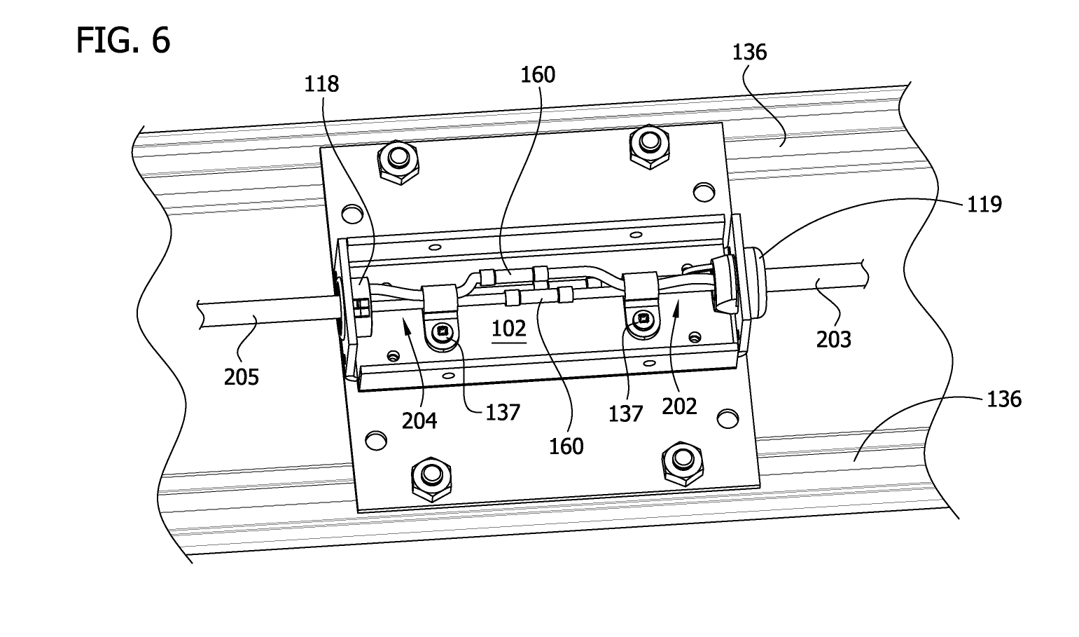

Referring to FIG. 1, the first housing 102 comprises a rectangular, planar base member 110, end walls 112 and side rails 114. The base member 112 has a plurality of openings 111 for receiving fasteners (e.g., nuts and bolts) which fasten the first housing 102 to the mounting plate 106. The end walls 112 each have a circular opening 116 for receiving a grommet 118, 119 (see FIGS. 5 and 6) for engaging the cables 203, 205 to be spliced together. Optionally, the side rails 114 may have openings 115 for receiving fasteners (e.g., nuts and bolts) which fasten the first housing 102 to the second housing 104. Optionally, the end walls 112 may have openings 113 for receiving fasteners (e.g., nuts and bolts) which fasten the first housing 102 to the second housing 104.

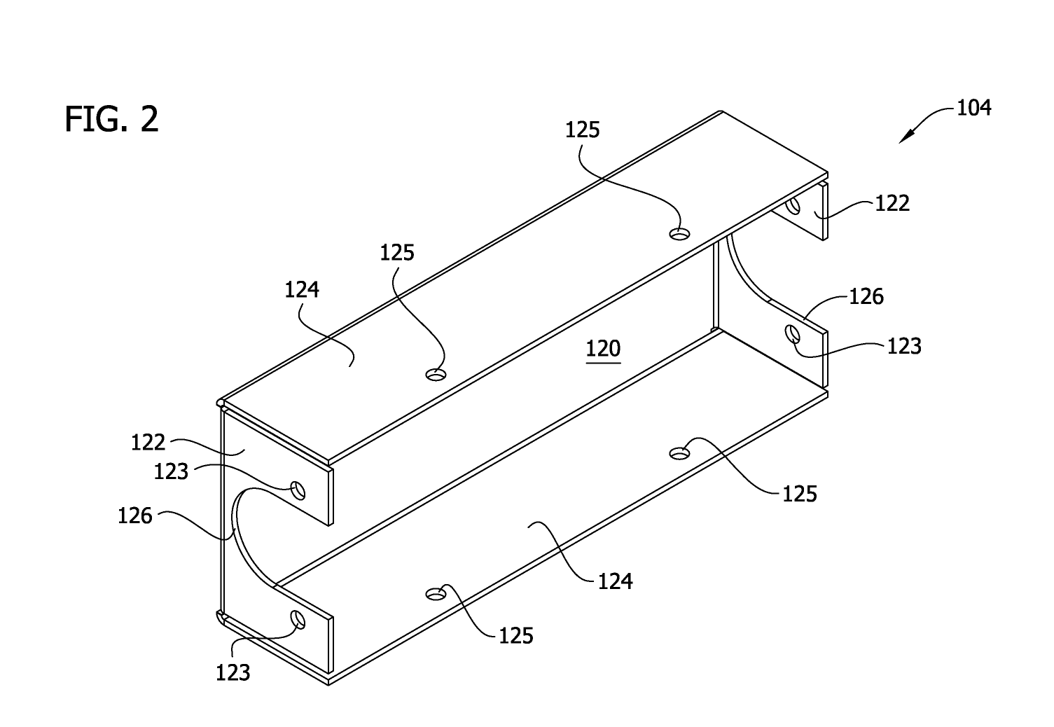

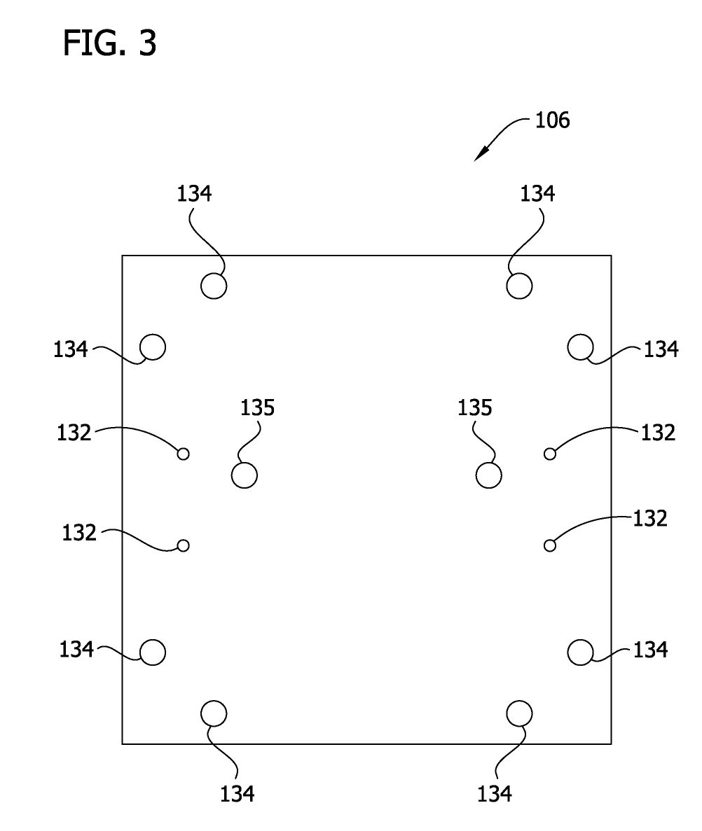

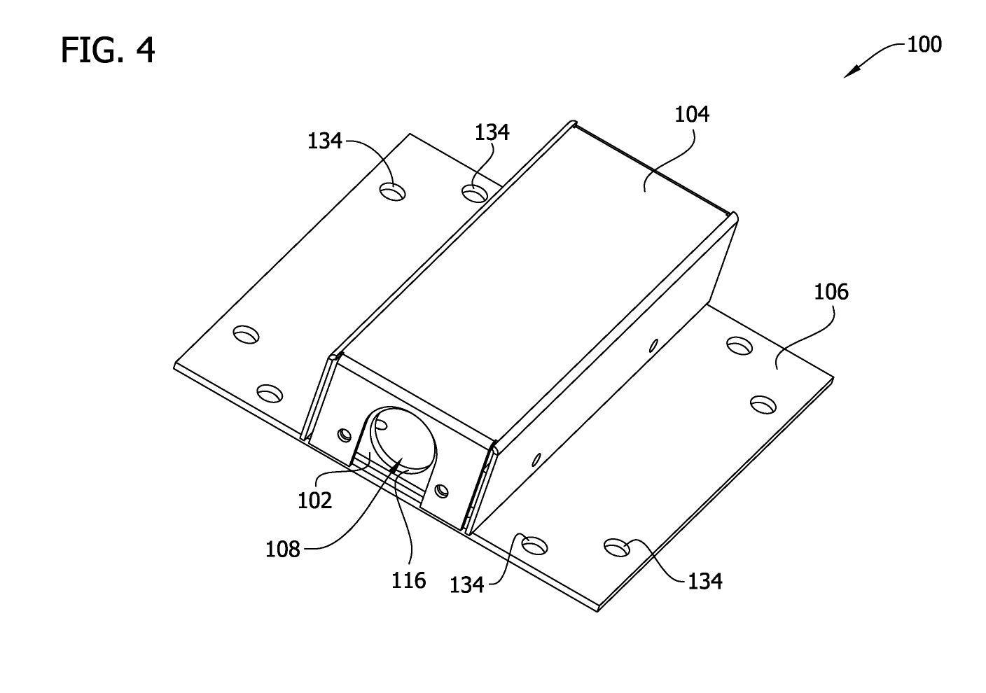

Referring to FIG. 2, the second housing 104 comprises a rectangular, planar element 120, end walls 122 and side walls 124. The end walls 122 each have a slot 126 for receiving the grommets 118, 119 in the circular opening 116 of the end walls 112 of the second housing 104. In one embodiment, the grommets may be different. For example, one grommet 119 for the cable 205 connected to the vehicle may be for strain relief and the other grommet 118 for the cable 203 connected to the light bar 200 may be a universal bushing. The second housing 104 slides over the first housing 102 to form a closed, water resistant compartment within with the spliced wires are located. Optionally, the side walls 124 may have openings 125 which align with openings 115 (when the first housing and second housing are mated). Openings 115, 125 receive fasteners (e.g., nuts and bolts) which fasten the second housing 104 to the first housing 102. Optionally, the end walls 122 may have openings 123 which align with openings 113 (when the first housing and the second housing are mated). Openings 113, 123 receive fasteners (e.g., nuts and bolts) which fasten the second housing 104 to the first housing 102.

[ 0017 ] Referring to FIG. 3, the support plate 106 is a rectangular, planar baseplate having two sets of opening. One set of openings 132 align with openings 111 (when the first housing and plate are joined) for receiving fasteners (e.g., nuts and bolts) which fasten the first housing 102 to the plate 106. The other set of openings 134 align with channels 136 (see FIGS. 5-6) in a frame 222 of the light bar 200 (when the junction box assembly 100 is mounted on the light bar 200). Openings 134 and channel 136 receive fasteners (e.g., nuts and bolts) which fasten the junction box assembly 100 to the frame 222 of the light bar 200. The openings 134 have several spaced apart locations in order to align with and engage different frames having different spaced apart channels.

[ 0018 ] As shown in FIGS. 4-6, the second housing 104 mates with the first housing 102 which is mounted on the plate 106 for form a water resistant junction box assembly 100 for mounting on the frame 222 on the underside of the light bar 200. A gasket or other sealing material may be positioned between the second housing 104 and the first housing 102 to inhibit moisture from entering the compartment within which the spliced wires 160 are positioned. The spliced wired may be joined by wire nuts, electrical tape or other connectors. Two spliced wires are shown in FIG. 6 as exemplary. The number of spliced wires within the junction box 100 will be at least two or more, depending on the light bar 200 and the number of wires in the new replacement light bar cable 203. Fasteners 140 (e.g., nuts and bolts) are positioned within openings 115, 125 to seal and hold together the first housing and the second housing. Fasteners 150 (e.g., nuts and carriage bolts) are positioned within the openings 134 and channels 136 to hold the plate 106 of the assembly 100 to the frame 222 of the light bar 200. In one embodiment, the frame 222 of the light bar 200 comprises a longitudinal member have channels 138 along its longitudinal axis so that the fasteners 150 slideably engage the channels such that the junction box assembly 100 may be positioned along the longitudinal axis of the longitudinal member. In other words, the fasteners 150 slide within the channels 136 of the frame 222 so that the assembly can be conveniently located under the light bar 200 at a location that does not interference with any other structures, such as a mounting foot which support the light bar 200 on the vehicle 208. For example, see U.S. Pat. No. 7,789,530 which illustrates a light bar having a longitudinal frame in the form of an extruded aluminum rail. Optional openings 133 in the first housing 102 may align with openings 135 in the support plate 106 for engaging screws 137 which hold clamps engaging the spliced wires of ends 202, 204.

In one embodiment, the invention comprises method of installing a light bar 200 having a replacement light bar cable 203 connected to a plurality of light emitting devices 218. The method installs the light bar 200 to a vehicle 208 having an existing vehicle light bar cable 205 connected to a power source 210. One end 202 of the light bar cable 203 is spliced to one end 204 of the existing vehicle light bar cable 205. The second housing 104 is mated to the first housing 102 so that the spliced wires of the cables are positioned with a compartment within the junction box assembly. The method includes mounting the junction box assembly 100 to the light bar 200, such as by mounting the assembly 100 to the frame 222 of the light bar 200.

### Installation Instructions

These instructions describe one method for electrically connecting an existing vehicle light bar cable 205 to a new replacement light bar cable 203. This method of installation speeds the process of upgrading a vehicle 208 with new lighting technology. The junction box assembly 100 is mounted externally to the light bar 200 to the underside of the light bar frame 222.

The instructions are as follows:
1. Place the new replacement light bar 200 near the old light bar and determine how much of the existing vehicle light bar cable 205 will be needed to reach the junction box 100 mounted to the underside of the frame 222 the replacement light bar 200. Please remember that the junction box 100 can be moved back and forth along the carriage bolt channel 136 to meet up with the existing vehicle light bar cable 205. Remove the replacement light bar 200 temporarily.
2. Trace the light bar functions of the existing vehicle light bar to the corresponding conductors and note their color (i.e. Red & Red/black wires control outboard rotating lights). Refer to a table provided to reference some very general wiring conventions. Then, cut the existing vehicle light bar cable 205 from the existing light bar where it goes into the old, existing light bar.
3. Remove the existing light bar. NOTE: The mounting blocks or feet should remain to mount the replacement light bar 200.
4. Determine whether the replacement light bar 200 can be mounted directly to the old mounts. The spacing between the carriage bolt tracks 136 on most replacement light bar is 3.75″. The carriage bolt diameter is 5/16″. Make any modifications necessary (new mounts, drill new openings, etc.) and make sure the replacement light bar 200 can be mounted. Do not mount the bar at this time.
5. Place the replacement light bar 200 upside down near where it will be mounted (put something down to protect the top of lenses from being scratched).
6. Strip the cable jacket of the end 204 of the existing vehicle light bar cable 205 back far enough to expose approximately 3″ of the conductors within the jacket. Refer to the wire tag (found on the replacement light bar cable 203 of the replacement light bar 200) for functions and their corresponding conductor (and color wire).
7. Strip the conductors of the end 202 that will be used to connect to the replacement light bar cable 203 about ⅜″ to allow crimping of a spade terminal. Connect the supplied terminals to the conductors (multiple if necessary) using a crimping tool (not provided). All other conductors should be terminated with wire nuts or crimp caps (some provided). If they are not covered, they may create a short in the junction box.
8. Connect newly terminated conductors of the end 204 of the existing vehicle light bar cable 205 to the end 202 of the replacement light bar cable 203 making sure that switch functions match up with light bar components.
9. Place junction box second housing 104 onto the first housing 102 making sure that no conductors are pinched. Screw the part of junction box together.
10. Turn the replacement light bar 200 right side up and place it onto the existing mounting. Test the replacement light bar 200 before fastening the light bar 200 to the mounting.

The above summary is provided to introduce a selection of concepts in simplified form that are further described below in the Detailed Description. The summary is not intended to identify key features or essential features of the claimed subject matter, nor is it intended to be used as an aid in determining the scope of the claimed subject matter.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

The Abstract and summary are provided to help the reader quickly ascertain the nature of the technical disclosure. They are submitted with the understanding that they will not be used to interpret or limit the scope or meaning of the claims.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A replacement light bar for connection to an existing vehicle light bar cable of a vehicle existing light bar which is being replaced, said replacement light bar comprising:
a frame;
at least one module attached to the frame and having a plurality of light emitting devices connected to a replacement light bar cable; and
a junction box assembly mounted to the frame and defining an compartment for receiving an end of the replacement light bar cable and for receiving an end of the existing vehicle light bar cable.

2. The replacement light bar of claim 1 wherein the junction box assembly comprises a multipart housing forming a compartment and having at least two separable parts for accessing the compartment, wherein the compartment is configured for receiving an end of the replacement light bar cable and for receiving an end of the existing vehicle light bar cable, said multipart housing configured to mount externally to the underside of the light bar.

3. The replacement light bar of claim 2 wherein the multipart housing comprises:
a first housing;
a second housing for engaging the first housing to define the compartment for receiving the end of the replacement light bar cable and for receiving the end of the existing vehicle light bar cable to be spliced to the end of the replacement light bar cable.

4. The replacement light bar of claim 3 further comprising a support plate mounted to the first housing for engaging the replacement light bar.

5. The replacement light bar of claim 3 wherein the first housing includes grommets for engaging the cables and the second housing has slots for receiving the grommets and the cables.

6. The replacement light bar of claim 3 wherein the first housing comprises a first base member, first end walls and first side rails, the first end walls having openings for receiving grommets for engaging the cables.

7. The replacement light bar of claim 6 the second housing comprises a second housing comprises a second base member, second end walls and second side rails, wherein the second end walls have slots for receiving the grommets when the first housing and second housing are joined together to form the compartment.

8. The replacement light bar of claim 3 further comprising a support plate mounted to the first housing for engaging the replacement light bar and wherein the frame comprises a longitudinal member have channels along its longitudinal axis and wherein a fastener connected to the support plate slidably engages the channels so that the junction box assembly may be positioned along the longitudinal axis of the longitudinal member.

9. A method of installing a replacement light bar having a replacement light bar cable connected to a plurality of light emitting devices of the replacement light bar, said method for installing the replacement light bar to a vehicle having an existing vehicle light bar which will be replaced and having an existing light bar cable connected to a power supply of the vehicle, said method comprising:
splicing an end of the replacement light bar cable to an end of the existing vehicle light bar cable;
enclosing the spliced ends of the cables in a junction box assembly; and
attaching the junction box assembly to the replacement light bar.

10. The method of claim 9 wherein said attaching comprises mounting the junction box assembly externally to the replacement light bar to the underside of the light bar.

11. The method of claim 10 wherein the junction box assembly comprises a multipart housing forming a compartment and having at least two separable parts for accessing the compartment, wherein the compartment is configured for receiving an end of the replacement light bar cable and for receiving an end of the existing vehicle light bar cable, said multipart housing configured to mount externally to the underside of the light bar.

12. The method of claim 11 wherein the multipart housing comprises:
a first housing; and
a second housing for engaging the first housing to define the compartment for receiving the end of the replacement light bar cable and for receiving the end of the existing vehicle light bar cable to be spliced to the end of the replacement light bar cable.

13. The method of claim 11 wherein the multipart housing further comprises a support plate mounted to the first housing for engaging the replacement light bar, wherein the replacement light bar has a frame comprising a longitudinal member have channels along its longitudinal axis, and said method further comprising:
connecting a fastener to the support plate to slidably engage the channels of the longitudinal member of the replacement light bar; and
sliding the junction box assembly along the channels to position the junction box assembly along the longitudinal axis of the longitudinal member of the frame of the replacement light bar.

14. A junction box assembly for a replacement light bar for splicing a replacement light bar cable and an existing vehicle light bar cable, said junction box assembly comprising a multipart housing forming a compartment and having at least two separable parts for accessing the compartment, wherein the compartment is configured for receiving an end of the replacement light bar cable and for receiving an end of the existing vehicle light bar cable, said multipart housing configured to mount externally to the underside of the light bar.

15. The junction box assembly of claim 14 wherein the multipart housing comprises:
a first housing;
a second housing for engaging the first housing to define the compartment for receiving the end of the replacement light bar cable and for receiving the end of the existing vehicle light bar cable to be spliced to the end of the replacement light bar cable.

16. The junction box assembly of claim 15 further comprising a support plate mounted to the first housing for engaging the replacement light bar.

17. The junction box assembly of claim 15 wherein the first housing includes grommets for engaging the cables and the second housing has slots for receiving the grommets and the cables.

18. The junction box assembly of claim 15 wherein the first housing comprises a first base member, first end walls and first side rails, the first end walls having openings for receiving grommets for engaging the cables.

19. The junction box assembly of claim 18 the second housing comprises a second housing comprises a second base member, second end walls and second side rails, wherein the second end walls have slots for receiving the grommets when the first housing and second housing are joined together to form the compartment.

20. The junction box assembly of claim 19 further comprising a support plate mounted to the first housing for engaging the replacement light bar and wherein the first housing includes grommets for engaging the cables and the second housing has slots for receiving the grommets and the cables.
